(19) United States
(12) Patent Application Publication
(10) Pub. No.: US 2025/0187853 A1
(43) Pub. Date: Jun. 12, 2025

(54) SYSTEMS AND METHODS FOR PICKING ITEMS

(71) Applicant: HITACHI, Ltd., Tokyo (JP)

(72) Inventors: Jie HU, Northville, MI (US); Nobutaka KIMURA, Holland, MI (US)

(21) Appl. No.: 18/537,323

(22) Filed: Dec. 12, 2023

(51) Int. Cl. B65G 47/90

(52) U.S. Cl. CPC B65G 47/905

(57) ABSTRACT

A method for recognizing and unloading a plurality of objects, which may include, until the plurality of objects has been unloaded, iteratively performing: collecting, by a processor, object data through a vision sensor; performing, by the processor, object recognition by determining object orientation and object location based on the object data; for an object of the plurality of objects being recognized and determined as available for picking, picking up and unloading the object using a robotic device; and for no object being determined as available for picking, performing: determining, by the processor, occurrence of object recognition error; for the object recognition error being detected, performing, by the processor, a recovery process to address the object recognition error; and for the object recognition error not being detected, recognizing, by the processor, completion in unloading of the plurality of objects.

### BACKGROUND

### Field

The present disclosure is generally directed to a method and a system for performing object recognition and unloading.

### Related Art

As part of their business operations, depalletization of items from pallets are performed by retailers, wholesalers, and other third-party logistic vendors. Some pallets may only have one type of package, or single Stock Keeping Unit (SKU), while others may contain different types of packages, also known as mixed-SKU. Robotic devices such as robotic arms have been used in performing palletization and depalletization of both single-SKU and mixed-SKU.

In the related art, recognition software utilizing computer vision techniques (e.g. classic rule-based methods, machine learning based methods, etc.) have been developed and utilized in recognizing objects and their locations. On performance of object recognition, robotic devices then proceed to pick/grasp and move the identified object based on the recognition results. However, challenges remain where the recognition software is unable to correctly recognize the items/objects, which leads to failed palletization and depalletization. This is especially problematic for mixed-SKU depalletization since many types of objects are involved.

In the related art, a method for performing remote perception assistance and object identification modification is disclosed. Remote assistance is requested to verify and provide modification to object identification. Based on the modification, additional processing tasks on the objects are then performed by a robot.

In the related art, a method for training machine learning models to identify objects for picking is disclosed. Data used in training the machines learning models are collected from edge cases where the machine learning models fail to detect objects.

Currently, remote recovery is required when faulty recognition results or errors occur. Remote recovery is performed by having the robotic device send an image of objects on the pallet to a human operator, who then performs object area selection on an object that was not detected or mistakenly grouped with another object (e.g. generating a rectangular area on an object), and commands the robotic device to pick/grasp the now identified object. However, this remote recovery process is insufficient for the following two reasons: 1) manual object selection as performed by humans can be time-consuming due to the complexity of object selection and laborious annotations; and 2) the degree of recognition/recognition capability of the recognition software is not improved when useful information such as object boundaries are not provided or utilized.

FIGS. 1(A)-(C) illustrate an example process flow of a conventional recovery process. As illustrated in FIG. 1(A), recognition errors have occurred and identified. Various recognition errors are associated with the objects illustrated in FIG. 1(A). Specifically, the top left object and the top right object were unrecognized, the center object had an orientation error, the bottom right object was misaligned, and the bottom left objects were falsely undivided. Using the center object on pallet 100 as example, an orientation error has been identified and requires remote recovery assistance. As illustrated in FIG. 1(B), the center object is remotely selected by a human operator under the recovery approach. Determining which object to select and highlighting the object require expertise and could be time-consuming. As illustrated in FIG. 1(C), information required to improve the object recognition functions are manually annotated, which incurs additional cost and time.

### SUMMARY

Aspects of the present disclosure involve an innovative method for recognizing and unloading a plurality of objects. The method may include, until the plurality of objects has been unloaded, iteratively performing: collecting, by a processor, object data through a vision sensor; performing, by the processor, object recognition by determining object orientation and object location based on the object data; for an object of the plurality of objects being recognized and determined as available for picking, picking up and unloading the object using a robotic device; and for no object being determined as available for picking, performing determining, by the processor, occurrence of object recognition error; for the object recognition error being detected, performing, by the processor, a recovery process to address the object recognition error; and for the object recognition error not being detected, recognizing, by the processor, completion in unloading of the plurality of objects.

Aspects of the present disclosure involve an innovative non-transitory computer readable medium, storing instructions for recognizing and unloading a plurality of objects. The instructions may include, until the plurality of objects has been unloaded, iteratively performing: collecting, by a processor, object data through a vision sensor; performing, by the processor, object recognition by determining object orientation and object location based on the object data; for an object of the plurality of objects being recognized and determined as available for picking, picking up and unloading the object using a robotic device; and for no object being determined as available for picking, performing determining, by the processor, occurrence of object recognition error; for the object recognition error being detected, performing, by the processor, a recovery process to address the object recognition error; and for the object recognition error not being detected, recognizing, by the processor, completion in unloading of the plurality of objects.

Aspects of the present disclosure involve an innovative server system for recognizing and unloading a plurality of objects. The server system may include, until the plurality of objects has been unloaded, iteratively performing: collecting, by a processor, object data through a vision sensor; performing, by the processor, object recognition by determining object orientation and object location based on the object data; for an object of the plurality of objects being recognized and determined as available for picking, picking up and unloading the object using a robotic device; and for no object being determined as available for picking, performing determining, by the processor, occurrence of object recognition error; for the object recognition error being detected, performing, by the processor, a recovery process to address the object recognition error; and for the object recognition error not being detected, recognizing, by the processor, completion in unloading of the plurality of objects.

Aspects of the present disclosure involve an innovative system for recognizing and unloading a plurality of objects. The system may include, until the plurality of objects has been unloaded, iteratively performing: means for collecting object data through a vision sensor; means for performing object recognition by determining object orientation and object location based on the object data; for an object of the plurality of objects being recognized and determined as available for picking, means for picking up and unloading the object using a robotic device; and for no object being determined as available for picking, performing means for determining occurrence of object recognition error; for the object recognition error being detected, means for performing a recovery process to address the object recognition error; and for the object recognition error not being detected, means for recognizing completion in unloading of the plurality of objects.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIGS. 1(A)-(C) illustrate an example process flow of a traditional recovery process.

FIG. 2 illustrates an example system 200, in accordance with an example implementation.

FIG. 3 illustrates an example process flow 300 for performing object recognition and unloading, in accordance with an example implementation.

FIGS. 4(A)-(B) illustrate an example remote recovery process, in accordance with an example implementation.

FIG. 5 illustrates an example recognition error detection process, in accordance with an example implementation.

FIG. 6 illustrates an alternative process flow 600 for performing object recognition and unloading, in accordance with an example implementation.

FIGS. 7(A)-(B) illustrate an example confidence threshold update process, in accordance with an example implementation.

FIG. 8 illustrates an alternative process flow 800 for performing object recognition and unloading, in accordance with an example implementation.

FIG. 9 illustrates example ML model training and testing processes, in accordance with an example implementation.

FIG. 10 illustrates an example process flow 1000 for performing object recognition and unloading using learnable object recognition functions, in accordance with an example implementation.

FIG. 11 illustrates an example graphic user interface (GUI) 1100 for performing area selection and error type indication, in accordance with an example implementation.

FIG. 12 illustrates an example computing environment with an example computing device suitable for use in some example implementations.

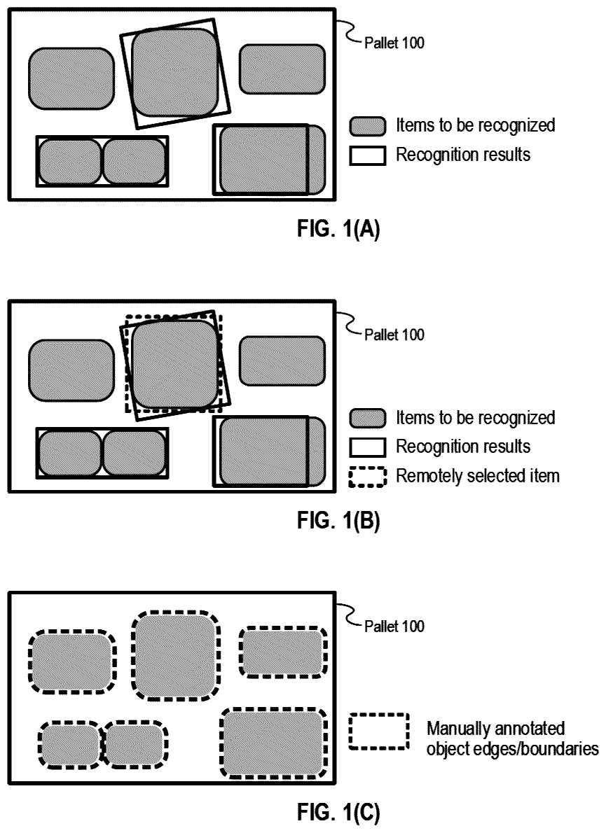

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

Present example implementations relate to methods and systems for performing recognizing and unloading a plurality of objects. Example implementations utilize simple but informative input from human operators during remote recovery, which can be used to automatically generate useful information that improve the overall recognition functions/processes.

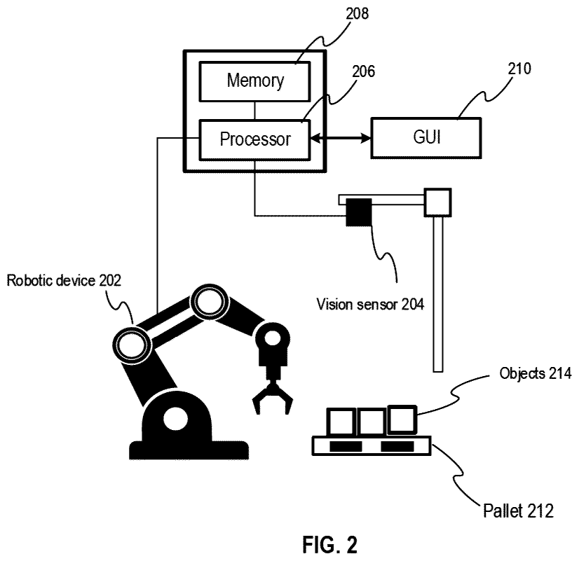

FIG. 2 illustrates an example system 200, in accordance with an example implementation. The system 200 may be used for palletization/depalletization of single-SKU or mixed-SKU. The system 200 may include components such as, but not limited to, a robotic device 202, a vision sensor 204, a processor 206, and a memory 208. The robotic device 202 may be a robotic arm that performs the functions of picking/grasping and moving of objects. The vision sensor 204 may be a camera directed at a pallet 212 that contains a number of objects 214. The vision sensor 204 captures images or videos of the objects 214 on the pallet 212, and the images or videos are then used to measure the objects 214. In some example implementations, the vision sensor captures the objects 214 in data formats other than images or videos, for example, point clouds, etc.

The processor 206 performs data processing on the data (e.g. images, videos, etc.) collected from the vision sensor 204 and issues commands to the robotic device 202 for controlling the movements of the robotic device 202. Specifically, the processor 206 performs object recognition using the collected data. The memory 208 stores the collected data from the vision sensor 204, the recognition data as generated by the processor 206, as well as instructions/programs that are being used in the various components of system 200. Request for performing remote recovery can be sent to a user/operator through a graphic user interface (GUI) 210. The collected data and recognition result as generated from object recognition can be sent to the user/operator for review on the GUI 210, and a user response to the request can be inputted through the GUI 210 and received at the processor 206.

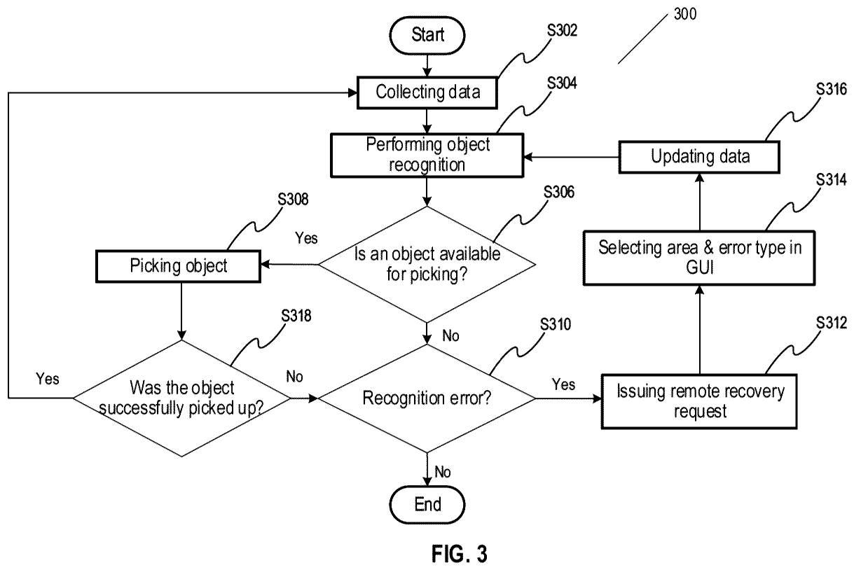

FIG. 3 illustrates an example process flow 300 for performing object recognition and unloading, in accordance with an example implementation. The process flow 300 begins at step S302 where object data is collected/measured using the vision sensor 204. At step S304, object recognition is performed to recognize locations and orientations (e.g. object dimensions, etc.) of the objects using the collected data, and identify availability of objects for picking (e.g. an object may be recognized but may not manipulatable due to object overlay or obstructions, etc.) Object recognition may be performed using at least one of learning-based methods and/or rule-based methods.

At step S306, a determination is made as to whether an object has been recognized and available for picking based on performed objection recognition. If an object is recognized as available for picking, then the process proceeds to step S308 where the recognized object is picked up/grasped and moved. At step S318, a determination is made as to whether the object was successfully picked up. If the answer is yes at step S318, the process then returns to step S302 where collection of object data is reperformed. If the answer is no at step S318, then the process proceeds to step S310, which is described in more detail below.

If no object is recognized as available for picking at step S306, then the process continues to step S310 where determination is made as to whether a recognition error has occurred. In some example implementations, recognition error detection is performed by comparing the result of current objection recognition against results of prior object recognition (historical results) for inconsistencies. FIG. 5 illustrates an example recognition error detection process, in accordance with an example implementation. As illustrated in FIG. 5, recognition error detected where objects 502 were correctly recognized in a prior object recognition cycle/step but falsely recognized as a single object in the current step. In alternate example implementations, recognition error can be detected if the depth data in one image area indicates the existence of objects while no object is recognized. In alternate example implementations, failure to pick up and unload recognized objects may indicate a recognition error. In alternate example implementations, recognition errors may be present where none of the recognized objects is suitable for picking up and unloading. Whether an object is suitable for picking can be determined in many ways, for example, the minimum/maximum object size, potential collision with other objects, etc. If the answer is no at step S310, then die process comes to an end.

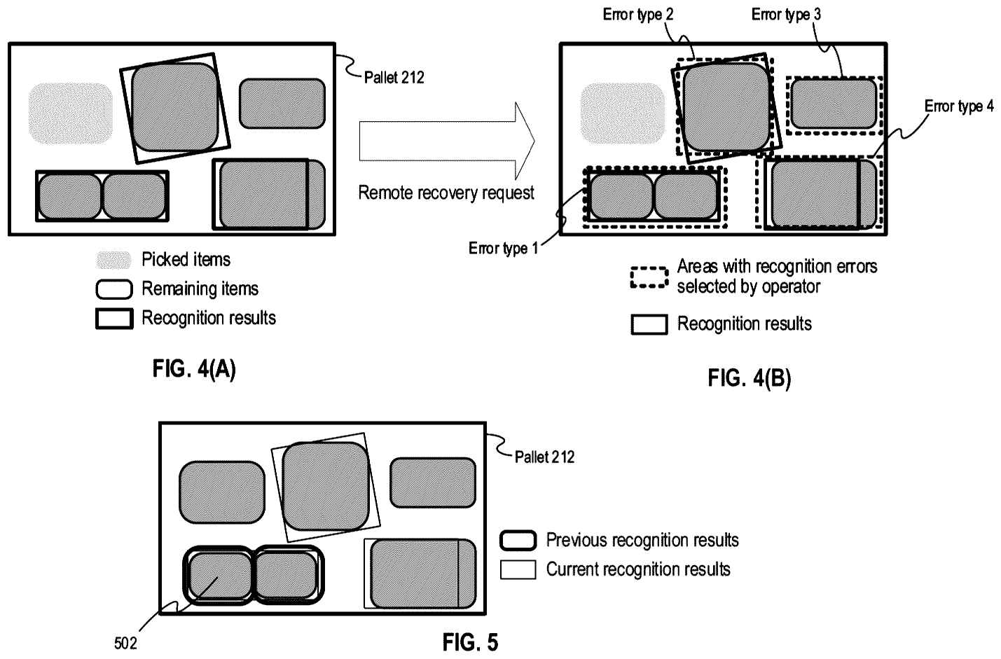

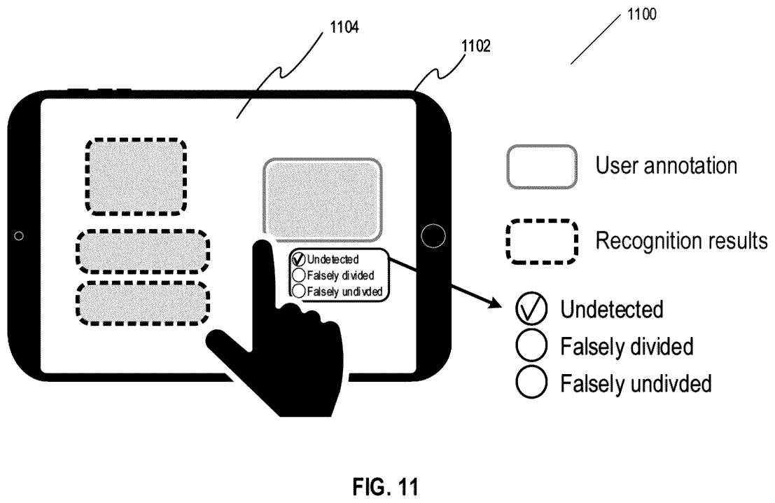

If a recognition error is detected at step S310, then a remote recovery request is sent/issued to a user/operator, along with the collected data/object for review at S312. At step S314, the user/operator then generates a correction response that includes selects area(s) on the collected object data where recognition error(s) has occurred and indicated error type(s) of the recognition error(s). FIGS. 4(A)-(B) illustrate an example remote recovery process, in accordance with an example implementation. As illustrated in FIG. 4(A), recognitions errors have been detected and a remote recovery request is sent/issued to a user/operator. As shown in FIG. 4(B), the user/operator makes selections on the provided object data and indicates the error types associated with the selected objects (e.g. error type 1, error type 2, error type 3, etc.) In some example implementations, area selection and error type indication can be made using a GUI. FIG. 11 illustrates an example GUI 1100 for performing area selection and error type indication, in accordance with an example implementation. A remote recovery request is received on a user device 1102 and displayed through a GUI 1104. Information to be displayed on the GUI 1104 may include current object arrangement and recognition result. As illustrated in FIG. 11, a user/operator can provide annotations such as boundary selection and error type identification.

Once user input is received, the collected data is then updated based on the user input at step S316, and object recognition is reperformed at step S304 using the updated data from step S316. The process flow 300 is performed iteratively until no object is left on the pallet for processing.

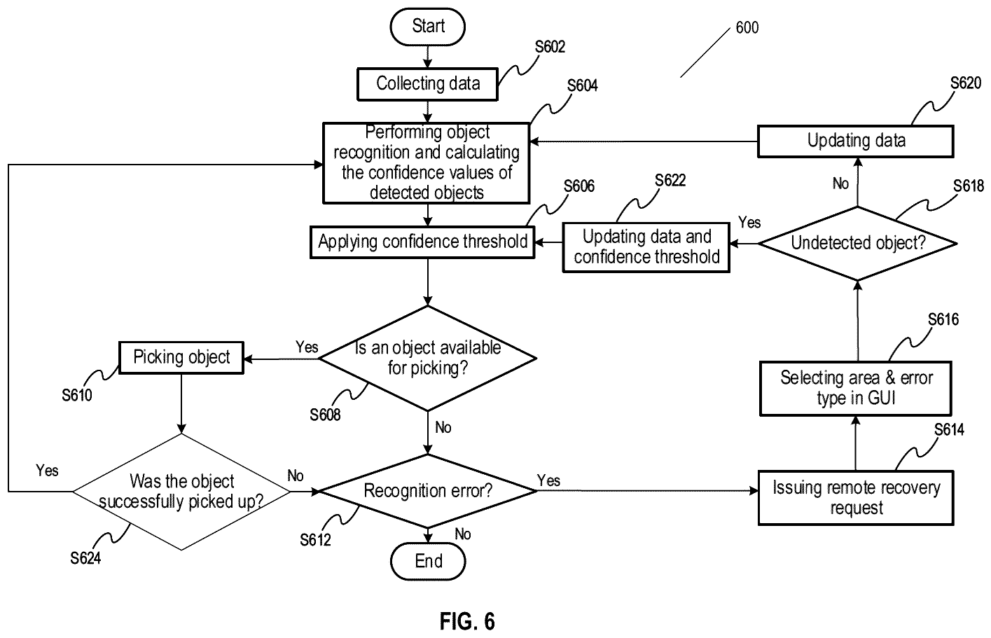

FIG. 6 illustrates an alternative process flow 600 for performing object recognition and unloading, in accordance with an example implementation. The process flow 600 is similar to the process flow 300 of FIG. 3, with the exception of a few additional steps. The process flow 600 begins at step S602 where object data is collected/measured using the vision sensor 204. At step S604, object recognition is performed to detect locations and orientations of the objects using the collected data, and object confidence calculation of objects is performed based on the determined locations and object orientations of the objects to generate confidence values. Alternatively, object confidence may be calculated using other methods such as, but not limited to, object probabilities output from neural networks during object recognition, etc. Each confidence value is associated with a corresponding object. Object recognition may be performed using at least one of a learning-based method or a rule-based method.

At step S606, a confidence threshold is applied and used in determining whether an object has been detected/recognized. At step S608, a determination is made as to whether an object has been recognized as available for picking based on confidence value comparison against the applied confidence threshold. Specifically, the confidence values of the objects are compared against the confidence threshold. If an object's threshold value is equal to or exceeds the confidence threshold, then the object is determined as detected/recognized. If the recognized object is identified as available for picking, the process then continues to step S610 where the recognized object is picked up/grasped and moved. At step S624, a determination is made as to whether the object was successfully picked up. If the answer is yes at step S624, the process then returns to step S602 where collection of object data is reperformed. If the answer is no at step S624, then the process proceeds to step S612, which is described in more detail below.

However, if no object is recognized as available for picking at step S608 (e.g. all objects having threshold values less than the confidence threshold, etc.), then the object is determined as undetected/unrecognized and the process proceeds to step S612 where determination is made as to whether a recognition error has occurred. In some example implementations, recognition error detection is performed by comparing the result of current objection recognition against results of prior object recognition (historical results) for inconsistencies. If the answer is no at step S612, then the process comes to an end.

If a recognition error is detected at step S612, then a remote recovery request is sent/issued to a user/operator, along with the collected object for review at step S614. At step S616, the user/operator then selects area(s) on the collected object data where recognition error(s) has occurred and indicates the error type(s) of the recognition error(s). In some example implementations, area selection and error type indication can be made using a GUI. The process then continues to step S618 where the user/operator determines if an undetected object caused by improper confidence threshold exists. If the answer to step S618 is no, then the process continues to step S620 where the collected data is then updated based on the user input, and object recognition is reperformed at step S604 using the updated data from step S620.

If the answer to step S618 is yes, then the process continues to step S622 where areas associated with undetected objects are made and confidence threshold adjustment is performed accordingly. Once the confidence threshold has been updated, the process then returns to step S606 where the updated confidence threshold is applied. The process flow 600 is performed iteratively until no object is left on the pallet for processing.

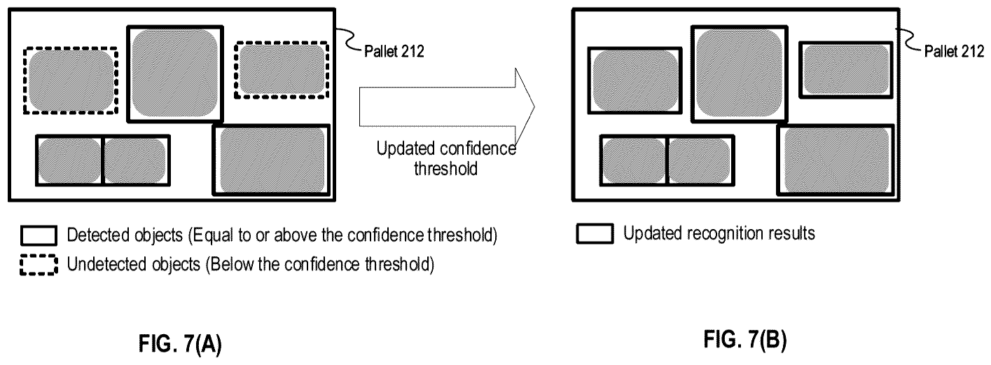

FIGS. 7(A)-(B) illustrate an example confidence threshold update process, in accordance with an example implementation. As illustrated in FIG. 7(A), undetected objects and detected objects are identified. Undetected objects are objects with confidence values that are below the confidence threshold, and detected objects are objects with confidence values that are equal to or exceed the confidence threshold. As shown in FIG. 7(B), the user/operator makes adjustment or updates to the confidence threshold, which then leads to detection of objects that were previously undetected.

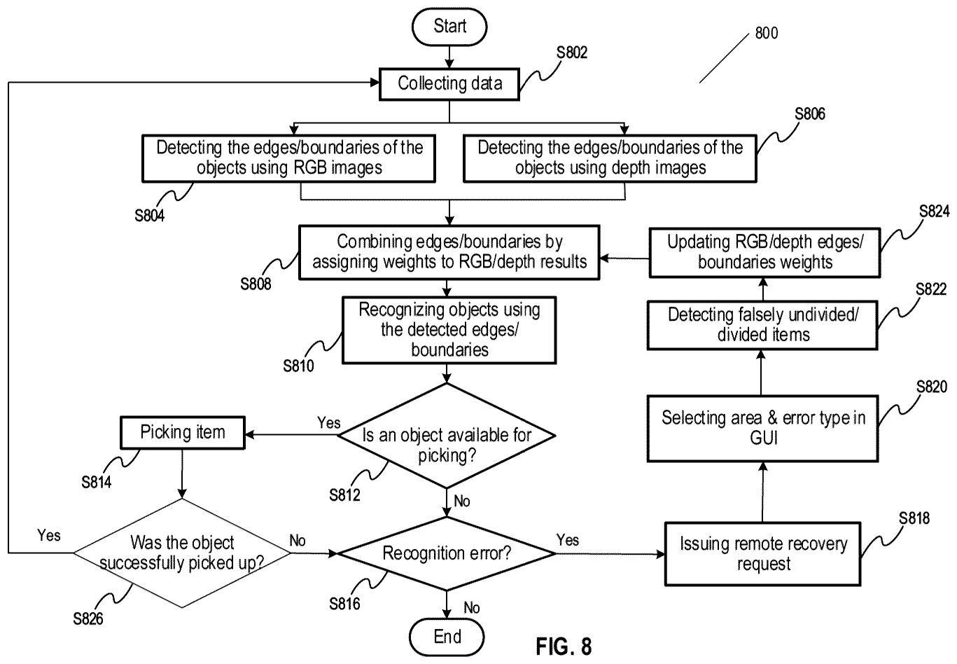

FIG. 8 illustrates an alternative process flow 800 for performing object recognition and unloading, in accordance with an example implementation. The process flow 800 utilizes neural networks in performing object recognition. The process flow 800 begins at step S802 where object data is collected/measured using the vision sensor 204. At step S804, detection of edges/boundaries of objects using red, green and blue (RGB) images is performed. At step S806, detection of edges/boundaries of objects using depth images is performed.

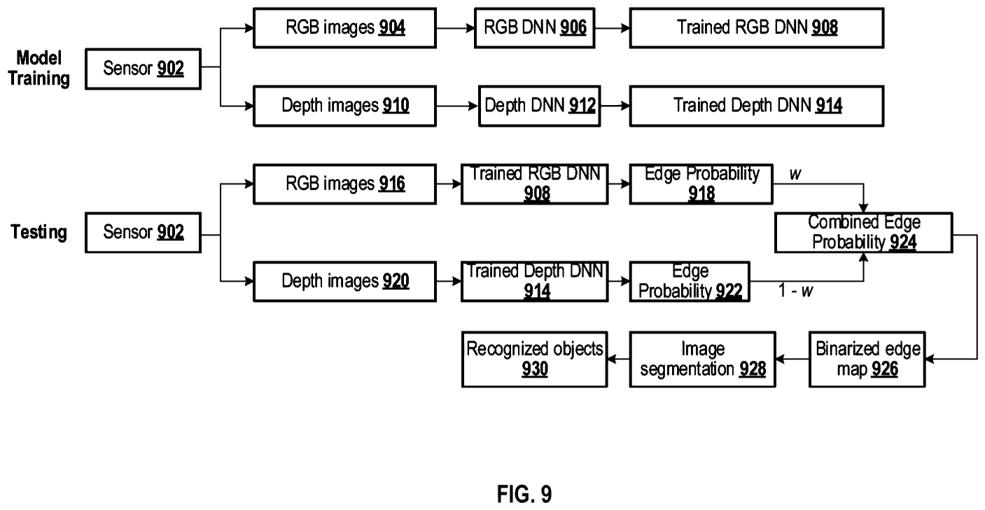

Object edge/boundary detection through RGB and depth images are performed using machine learning (ML) algorithms. FIG. 9 illustrates example ML model training and testing processes, in accordance with an example implementation. During the model training phase, a sensor 902, such as the vision sensor 204, is used to capture RGB images 904 and depth images 910 of the objects. In some example implementations, more than one sensor 902 may be utilized in performing capturing of the RGB images 904 and the depth images 910 of the objects. For example, a first sensor 902 may be used in capturing the RGB images 904 and a second sensor 902 may be used in capturing the depth images 910. The RGB images 904 and the depth images 910 are then used separately train two ML models. In some example implementations, Deep Neural Networks (DNN) are implemented as the ML models. As illustrated in FIG. 9, the RGB images 904 are used to train the RGB DNN 906 to generate trained RGB DNN 908. The depth images 910 are used to train the depth DNN 912 to generate trained depth DNN 914. The trained DNNs are utilized to detect the edges/boundaries of objects in the RGB images 904 and the depth images 910. Output of a trained DNN may include a set of edge/boundary probability images having pixel values representing likelihood of a pixel belonging to an edge/boundary.

During the implementation/testing phase, the sensor 902 captures RGB images 916 and depth image 920 of objects to be processed. In some example implementations, more than one sensor 902 may be utilized in performing capturing of the RGB images 916 and the depth images 920 of the objects. The RGB images 916 are sent to the trained RGB DNN 908 to generate a set of edge/boundary images indicating edge probability 918. The depth images 920 are sent to the trained depth DNN 914 to generate a set of edge/boundary images indicating edge probability 922. Weights are then assigned to the edge probability 918 and edge probability 922, and the two are then combined to generate combined edge probability 924.

Pixel values of the combined edge probability 924 are then compared against a threshold value to determine whether a pixel belongs to an edge/boundary. The result is a binarized edge map (binarized edge image 926) where each pixel is either an edge/boundary or not. Objects can then be recognized (recognized objects 930) using methods such as image segmentation 928 over the detected edges/boundaries.

Referring back to FIG. 8, edges % boundaries from the RGB image and the depth images are combined using weight assignment at step S808. At step S810, objects are recognized using the combined edges/boundaries. The process then continues to step S812 where a determination is made as to whether an object has been recognized as available for picking based on performed objection recognition. If an object is recognized as available for picking, then the process proceeds to step S814 where the recognized object is picked up/grasped and moved. At step S826, a determination is made as to whether the object was successfully picked up. If the answer is yes at step S826, the process then returns to step S802 where collection of object data is reperformed. If the answer is no at step S826, then the process proceeds to step S816, which is described in more detail below.

If no object is recognized as available for picking at step S812, then the process continues to step S816 where determination is made as to whether a recognition error has occurred. If the answer is no at step S816, then the process comes to an end. If a recognition error is detected at step S816, then a remote recovery request is sent/issued to a user/operator, along with the collected object for review at step S818. At step S820, the user/operator then selects area(s) on the collected object data where recognition error(s) has occurred and indicates the error type(s) of the recognition error(s). In some example implementations, area selection and error type indication can be made using a GUI.

At step S822, the user/operator determines existence of a falsely divided object or a failed object division (falsely undivided object). The process then continues to step S824 where adjustments are made to weights of the edge probabilities (edge probability 918 and edge probability 922). If false object division is present, then the weight associated with trained RGB DNN 908 (edge probability 918) is increased. Otherwise, the weight associated with trained RGB DNN 908 is decreased. In the alternative, the weight associated with trained depth DNN 914 (edge probability 922) may be decreased if false object division is detected and increased if failed object division is present. On completion of step S824, the process then returns to step S808 where updated weights are applied. The process flow 800 is performed iteratively until no object is left on the pallet for processing.

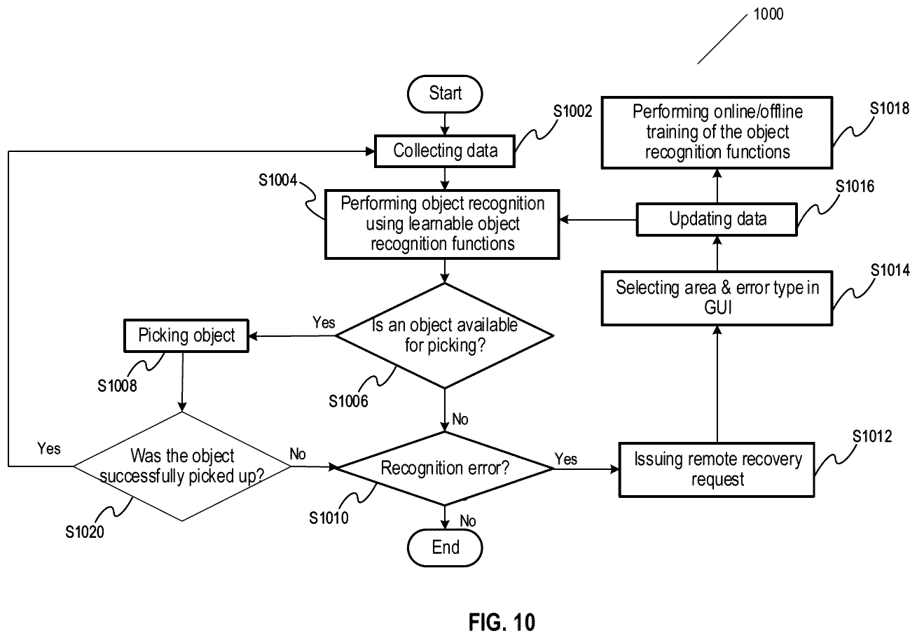

FIG. 10 illustrates an example process flow 1000 for performing object recognition and unloading using learnable object recognition functions, in accordance with an example implementation. The process flow 1000 begins at step S1002 where object data is collected/measured using the vision sensor 204. At step S1004, object recognition is performed on the collected data using learnable object recognition functions. As part of the object recognition, identification of availability of objects for picking is also performed.

At step S1006, a determination is made as to whether an object has been recognized as and available for picking based on performed objection recognition. If an object is recognized as available for picking, then the process proceeds to step S1008 where the recognized object is picked up/grasped and moved. At step S1020, a determination is made as to whether the object was successfully picked up. If the answer is yes at step S1020, the process then returns to step S1002 where collection of object data is reperformed. If the answer is no at step S1020, then the process proceeds to step S1010, which is described in more detail below.

If no object is recognized as available for picking at step S1006, then the process continues to step S1010 where determination is made as to whether a recognition error has occurred. In some example implementations, recognition error detection is performed by comparing the result of current objection recognition against results of prior object recognition (historical results) for inconsistencies. If the answer is no at step S1010, then the process comes to an end.

If a recognition error is detected at step S1010, then a remote recovery request is issued to a user/operator, along with the collected data/object for review at S1012. At step S1014, the user/operator then selects area(s) on the collected object data where recognition error(s) has occurred and indicates the error type(s) of the recognition error(s). Once user input is received, the collected data is then updated based on the user input at step S1016, and object recognition is reperformed at step S1004 using the updated data. In addition to reperformance of object recognition at step S1004, the learnable object recognition functions can be trained online or offline using the updated data to improve recognition accuracy of the functions at step S1018. For example, the trained DNNs (trained RGB DNN 908 and trained depth DNN 914) of FIG. 9 can be further trained using the update result. The process flow 1000 is performed iteratively until no object is left on the pallet for processing.

The foregoing example implementation may have various benefits and advantages. For example, example implementations allow reduction in costs and processing time associated with object recognition. Specifically, costs and processing time are reduced as result of reduction in annotation complexity. Furthermore, utilization of annotations and updated recognition result for online/offline function trainings provide improved recognition accuracy in object recognition.

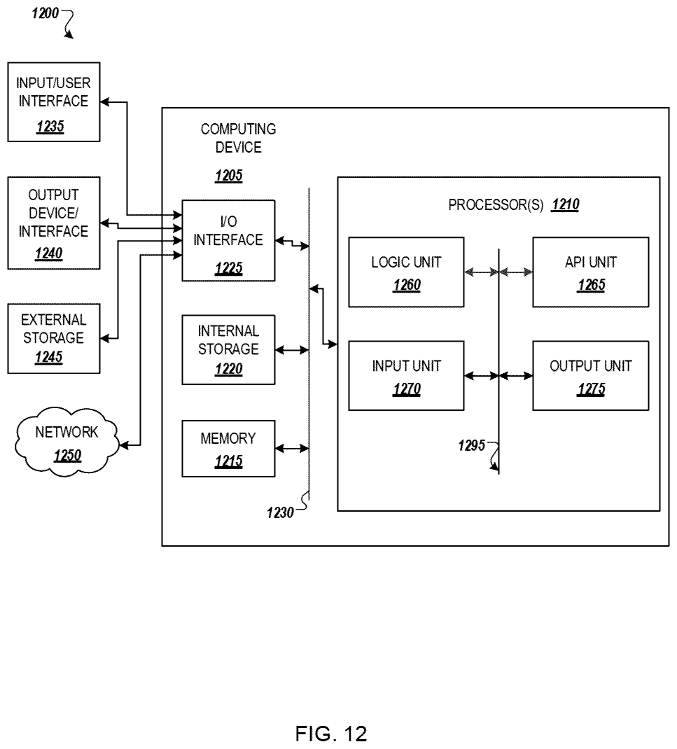

FIG. 12 illustrates an example computing environment with an example computer device suitable for use in some example implementations. Computer device 1205 in computing environment 1200 can include one or more processing units, cores, or processors 1210, memory 1215 (e.g., RAM, ROM, and/or the like), internal storage 1220 (e.g., magnetic, optical, solid-state storage, and/or organic), and/or IO interface 1225, any of which can be coupled on a communication mechanism or bus 1230 for communicating information or embedded in the computer device 1205. IO interface 1225 is also configured to receive images from cameras or provide images to projectors or displays, depending on the desired implementation.

Computer device 1205 can be communicatively coupled to input/user interface 1235 and output device/interface 1240. Either one or both of the input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via IO interface 1225) to external storage 1245 and network 1250 for communicating with any number of networked components, devices, and systems, including one or more computer devices of the same or different configuration. Computer device 1205 or any connected computer device can be functioning as, providing services of or referred to as a server, client, thin server, general machine, special-purpose machine, or another label.

IO interface 1225 can include but is not limited to, wired and/or wireless interfaces using any communication or 10 protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM. ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl. JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or in a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, the input unit 1270, the output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide an output based on the calculations described in example implementations.

Processor(s) 1210 can be configured to collect object data through a vision sensor as illustrated in FIG. 3. The processor(s) 1210 may also be configured to perform object recognition by determining object orientation and object location based on the object data as illustrated in FIG. 3. The processor(s) 1210 may also be configured to, for an object of the plurality of objects being recognized, pick up and unload the object using a robotic device as illustrated in FIG. 3. The processor(s) 1210 may also be configured to determine occurrence of object recognition error as illustrated in FIG. 3. The processor(s) 1210 may also be configured to, for tie object recognition error being detected, perform a recovery process to address the object recognition error as illustrated in FIG. 3. The processor(s) 1210 may also be configured to, for the object recognition error not being detected, recognize completion in unloading of the plurality of objects as illustrated in FIG. 3.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing.” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within die computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art firm consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for recognizing and unloading a plurality of objects, the method comprising:
until the plurality of objects has been unloaded, iteratively performing:
collecting, by a processor, object data through a vision sensor;
performing, by the processor, object recognition by determining object orientation and object location based on the object data;
for an object of the plurality of objects being recognized and determined as available for picking, picking up and unloading the object using a robotic device; and
for no object being determined as available for picking, performing:
determining, by the processor, occurrence of object recognition error;
for the object recognition error being detected, performing, by the processor, a recovery process to address the object recognition error; and
for the object recognition error not being detected, recognizing, by the processor, completion in unloading of the plurality of objects.

2. The method of claim 1, wherein the object orientation comprises object dimensions.

3. The method of claim 1, wherein the processor is configured to perform the recovery process to address the object recognition error by:
sending a recovery request containing the object data to a user:
receiving, in response to the recovery request, a correction response from the user,
wherein the correction response comprises at least one selected recognition error area and at least one type of recognition error; and
updating data for object recognition based on the correction response and reperforming object recognition.

4. The method of claim 3, wherein object recognition is performed using at least one learnable object recognition function.

5. The method of claim 4, wherein training of the at least one learnable object recognition function is performed online or offline.

6. The method of claim 3, wherein sending the recovery request containing the object data to the user comprises sending the recovery request to a graphic user interface (GUI) for the user to review.

7. The method of claim 3,
wherein the processor is configured to perform object recognition by performing object confidence calculation on the plurality of objects to generate confidence values, and each confidence value is associated with a corresponding object of the plurality of objects:
wherein recognition of an object of the plurality of objects is performed by:
comparing confidence value of the object against a confidence threshold,
for the confidence value of the object being equal to or exceed the confidence threshold, determining the object as recognized, and
for the confidence value of the object being less than the confidence threshold,
determining the object as not being recognized; and
wherein the processor is configured to perform the recovery process to address the object recognition error by further performing threshold adjustment on the confidence threshold.

8. The method of claim 3,
wherein the processor is configured to perform object recognition by:
performing object edge detection using red, green and blue (RGB) images of the plurality of objects to detect first object boundaries,
performing object edge detection using depth images of the plurality of objects to detect second object boundaries,
generating first probability images using the RGB images as input to a first trained machine learning model,
generating second probability images using the depth images as input to a second trained machine learning model,
assigning weights to the first probability images and the second probability images,
combining the first probability images and the second probability images based on the weights to generate a binarized edge map of the plurality of objects, and
performing object recognition of the plurality of objects using the binarized edge map; and
wherein the object data comprises the RGB images and the depth images.

9. The method of claim 8, wherein the processor is configured to perform the recovery process to address the object recognition error by further performing:
detecting existence of a falsely divided object or a falsely undivided object as result of object recognition; and
adjusting the weights assigned to the first probability images and the second probability images to improve object recognition.

10. The method of claim 9, wherein the processor is configured to adjust the weights assigned to the first probability images and the second probability images by:
for failed object division being detected, increasing a first weight of the weights or decreasing a second weight of the weights, wherein the first weight is associated with the first probability images and the second weight is associated with the second probability images; and
for a falsely divided object being detected, decreasing the first weight or increasing the second weight.

11. A system for recognizing and unloading a plurality of objects, the system comprising:
a robotic device;
a processor in communication with the robotic device, wherein, until the plurality of objects has been unloaded, the processor is configured to iteratively:
collect object data through a vision sensor;
perform object recognition by determining object orientation and object location based on the object data;
for an object of the plurality of objects being recognized and determined as available for picking, pick up and unload the object using a robotic device; and
for no object being determined as available for picking, perform:
determine occurrence of object recognition error;
for the object recognition error being detected, perform a recovery process to address the object recognition error; and
for the object recognition error not being detected, recognize completion in unloading of the plurality of objects.

12. The system of claim 11, wherein the object orientation comprises object dimensions.

13. The system of claim 11, wherein the processor is configured to perform the recovery process to address the object recognition error by:
sending a recovery request containing the object data to a user;
receiving, in response to the recovery request, a correction response from the user,
wherein the correction response comprises at least one selected recognition error area and at least one type of recognition error; and
updating data for object recognition based on the correction response and reperforming object recognition.

14. The system of claim 13, wherein object recognition is performed using at least one learnable object recognition function.

15. The system of claim 14, wherein training of the at least one learnable object recognition function is performed online or offline.

16. The system of claim 13, wherein sending the recovery request containing the object data to the user comprises sending the recovery request to a graphic user interface (GUI) for the user to review.

17. The system of claim 13,
wherein the processor is configured to perform object recognition by performing object confidence calculation on the plurality of objects to generate confidence values, and each confidence value is associated with a corresponding object of the plurality of objects;
wherein recognition of an object of the plurality of objects is performed by:
comparing confidence value of the object against a confidence threshold,
for the confidence value of the object being equal to or exceed the confidence threshold, determining the object as recognized, and
for the confidence value of the object being less than the confidence threshold,
determining the object as not being recognized; and
wherein the processor is configured to perform the recovery process to address the object recognition error by further performing threshold adjustment on the confidence threshold.

18. The system of claim 13,
wherein the processor is configured to perform object recognition by:
performing object edge detection using red, green and blue (RGB) images of the plurality of objects to detect first object boundaries,
performing object edge detection using depth images of the plurality of objects to detect second object boundaries,
generating first probability images using the RGB images as input to a first trained machine learning model,
generating second probability images using the depth images as input to a second trained machine learning model,
assigning weights to the first probability images and the second probability images,
combining the first probability images and the second probability images based on the weights to generate a binarized edge map of the plurality of objects, and
performing object recognition of the plurality of objects using the binarized edge map; and
wherein the object data comprises the RGB images and the depth images.

19. The system of claim 18, wherein the processor is configured to perform the recovery process to address the object recognition error by further performing:
detecting existence of a falsely divided object or a failed object division as result of object recognition; and
adjusting the weights assigned to the first probability images and the second probability images to improve object recognition.

20. The system of claim 19, wherein the processor is configured to adjust the weights assigned to the first probability images and the second probability images by:
for failed object division being detected, increasing a first weight of the weights or decreasing a second weight of the weights, wherein the first weight is associated with the first probability images and the second weight is associated with the second probability images; and
for a falsely divided object being detected, decreasing the first weight or increasing the second weight.
